(19) United States
(12) Patent Application Publication
(10) Pub. No.: US 2025/0313011 A1
(43) Pub. Date: Oct. 9, 2025

(54) INKJET RECORDING APPARATUS AND NOZZLE SURFACE CLEANING METHOD

(71) Applicant: Konica Minolta, Inc., Tokyo (JP)

(72) Inventor: Yohei ITO, Tokyo (JP)

(21) Appl. No.: 19/093,401

(22) Filed: Mar. 28, 2025

(30) Foreign Application Priority Data
Apr. 9, 2024 (JP) 2024-062966

(51) Int. Cl. B41J 2/165

(52) U.S. Cl. CPC B41J 2/16538; B41J 2002/16567

(57) ABSTRACT

An inkjet recording apparatus includes, an inkjet head that ejects ink from a nozzle provided on a nozzle surface; a head cleaner that performs a nozzle surface cleaning operation of rubbing and wiping the nozzle surface with a cleaning surface of a wipe member; and a hardware processor that causes ink to be supplied from the inkjet head to the cleaning surface of the wipe member. The head cleaner performs the nozzle surface cleaning operation in a state in which the cleaning surface of the wipe member is wetted with the ink, and sets a different region of the wipe member as the cleaning surface each time the nozzle surface cleaning operation is performed.

### CROSS-REFERENCE TO RELATED APPLICATIONS

The entire disclosure of Japanese Patent Application No. 2024-062966 filed on Apr. 9, 2024, is incorporated herein by reference in its entirety.

### BACKGROUND OF THE INVENTION

### Technical Field

The present invention relates to an inkjet recording apparatus and a nozzle surface cleaning method.

### Description of Related Art

Conventionally, an inkjet recording apparatus is known that records an image by ejecting ink from a nozzle surface and landing an ink at a desired position on a recording medium. In the inkjet recording apparatus, when the ink adheres to the nozzle surface, the ink is thickened and further solidified in a state where a part of the nozzle is blocked, and thus there is a concern that an ejection failure may occur. Therefore, it is common to remove the adhered ink by wiping the nozzle surface with a wiping member such as a cloth.

In particular, for example, Japanese Unexamined Patent Publication No. 2021-192967 proposes a configuration in which a cloth is reciprocated in a state where the cloth is pressed against a nozzle surface, thereby reducing an unwiped portion of the nozzle surface. In addition, for example, Japanese Unexamined Patent Publication No. 2006-334964 proposes a configuration in which unwiped portions of the nozzle surface are reduced by applying a cleaning liquid.

However, the invention of Japanese Unexamined Patent Publication No. 2021-192967 uses a dry cloth as the wiping member. Therefore, in a case where the residual ink is dried and thickened, the residual ink cannot be completely wiped off, with the result that an unwiped portion may be left behind. In addition, since the dry cloth has irregularities on the surface, the unwiped portion is likely to be generated.

The invention of Japanese Unexamined Patent Publication No. 2006-334964 can solve the above-described problem of Japanese Unexamined Patent Publication No. 2021-192967 because a cleaning liquid is applied. However, a dedicated device for applying the cleaning liquid is required. Therefore, the inkjet recording apparatus is increased in size and cost.

### SUMMARY OF THE INVENTION

The present invention has been conceived in view of such circumstances, and an object thereof is to provide an inkjet recording apparatus and a nozzle surface cleaning method that can appropriately wipe residual ink adhered to a nozzle surface while suppressing increase in size and cost of the apparatus.

According to one aspect of the present invention an inkjet recording apparatus includes,
an inkjet head that ejects ink from a nozzle provided on a nozzle surface;
a head cleaner that performs a nozzle surface cleaning operation of rubbing and wiping the nozzle surface with a cleaning surface of a wipe member; and
a hardware processor that causes ink to be supplied from the inkjet head to the cleaning surface of the wipe member,
wherein the head cleaner performs the nozzle surface cleaning operation in a state in which the cleaning surface of the wipe member is wetted with the ink, and sets a different region of the wipe member as the cleaning surface each time the nozzle surface cleaning operation is performed.

According to another aspect of the present invention, a nozzle surface cleaning method by an inkjet recording apparatus including, an inkjet head that ejects ink from a nozzle provided on a nozzle surface, and a head cleaner that performs a nozzle surface cleaning operation of rubbing and wiping the nozzle surface with a cleaning surface of a wipe member, the method including:
supplying ink from the inkjet head to a cleaning surface of the wipe member;
performing the nozzle surface cleaning operation in a state in which the cleaning surface of the wipe member is wetted with the ink; and
changing the cleaning surface by setting a different region of the wipe member as the cleaning surface each time the nozzle surface cleaning operation is performed.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a side view illustrating a schematic configuration of an inkjet recording apparatus according to an embodiment of the present invention;

FIG. 2 is a block diagram showing main operation elements of the inkjet recording apparatus according to one embodiment of the present invention;

FIG. 3 is a bottom view illustrating a configuration of a head unit;

FIG. 4 is a diagram illustrating a carriage that moves in a width direction;

FIG. 5 is a diagram illustrating a movable range of the carriage in the width direction;

FIG. 6A is a cross-sectional view of a cleaning section during purge maintenance;

FIG. 6B is a cross-sectional view of the cleaning section during a scraping operation;

FIG. 7 is a schematic configuration diagram of a head cleaner;

FIG. 8 is a flowchart of a nozzle surface cleaning operation;

FIG. 9A is a schematic illustration of a step of supplying ink to a wipe member;

FIG. 9B is a schematic diagram of a step of wiping a nozzle surface with a wipe member;

FIG. 9C is a schematic illustration of a step of forming a new cleaning surface by a winding roller;

FIG. 9D is a schematic diagram of a step of absorbing ink on a nozzle surface by a wipe member;

FIG. 10 is a schematic cross-sectional view of a split yam;

FIG. 11A is a graph which shows a relationship between elapsed time from the last nozzle surface cleaning operation and increasing viscosity of the ink on the nozzle surface; and

FIG. 11B is a graph illustrating a relationship between a mounting period of an inkjet head and water repellency of a nozzle surface of the inkjet head.

### DETAILED DESCRIPTION

Hereinafter, one or more embodiments of the present invention will be described with reference to the drawings. However, the scope of the invention is not limited to the disclosed embodiments.

In the following, preferred embodiments of the present invention will be described with reference to the drawings. However, the scope of the invention is not limited to the illustrated examples. In the following description, components having the same function and configuration are denoted by the same reference numerals, and description thereof is omitted.

### [Overall Configuration of Inkjet Recording Apparatus]

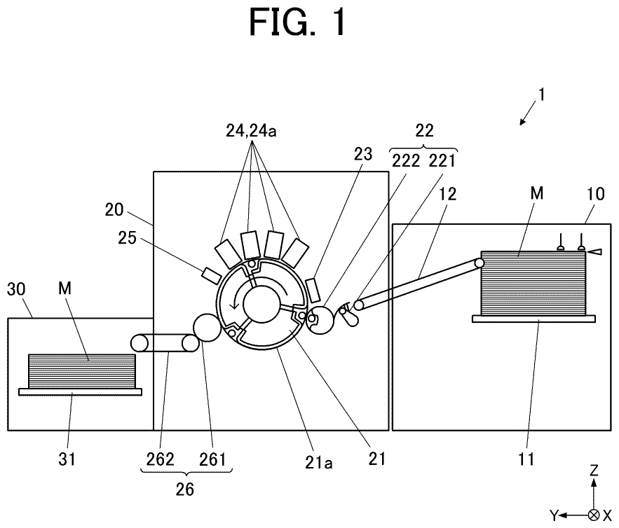

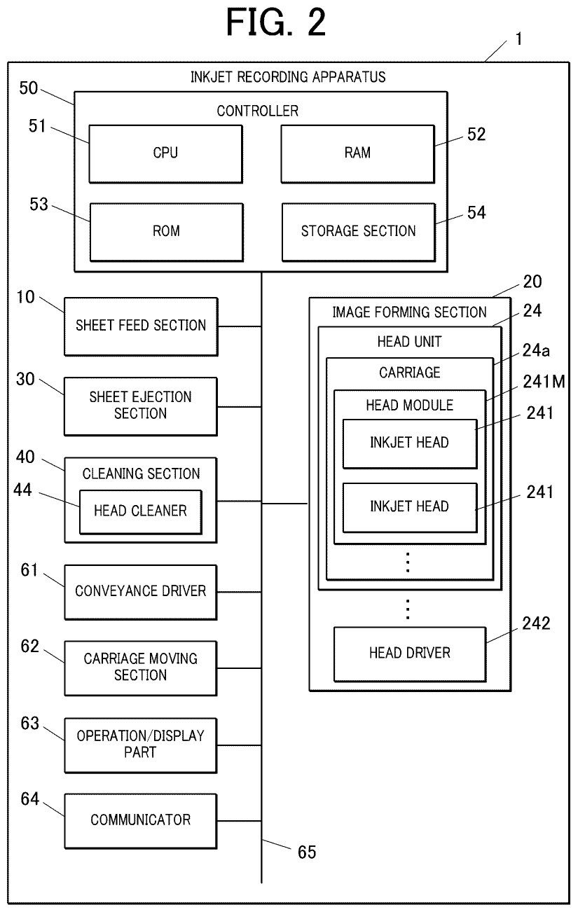

FIG. 1 is a schematic configuration of an inkjet recording apparatus 1 according to an embodiment of the present invention. FIG. 2 is a functional block diagram of the inkjet recording apparatus 1. The inkjet recording apparatus 1 includes a sheet feed section 10, an image forming section 20, a sheet ejection section 30, a cleaning section 40, and a controller 50 (hardware processor). In addition, each unit of the inkjet recording apparatus 1 is connected by a bus 65.

Under the control of the controller 50, the inkjet recording apparatus 1 conveys a recording medium M stored in the sheet feed section 10 to the image forming section 20. The inkjet recording apparatus 1 records an image on the recording medium M at the image forming section 20 and conveys the recording medium M having the image recorded thereon to the sheet ejection section 30.

As the recording medium M, in addition to sheets such as a plain sheet or a coated sheet, various media can be used on which ink having landed on the surface can be fixed, such as cloth or sheet-like resin.

Note that in the following, an X direction, a Y direction, and a Z direction are directions illustrated in FIG. 1. In the following description, the X direction, the Y direction, and the Z direction are also referred to as a width direction, a conveyance direction, and a height direction, respectively.

### (Sheet Feed Section)

The sheet feed section 10 includes a sheet feed tray 11 and a medium supplier 12. The sheet feed tray 11 stores the recording medium M. The medium supplier 12 conveys and supplies the recording medium M from the sheet feed tray 11 to the image forming section 20. The medium supplier 12 includes a belt. The belt has a ring shape, and an inner side of the belt is supported by two rollers. The medium supplier 12 rotates the rollers with the recording medium M placed on the belt. Under such control, the medium supplier 12 conveys the recording medium M from the sheet feed tray 11 to the image forming section 20.

### (Image Forming Section)

The image forming section 20 includes a conveyance drum 21, a handover unit 22, a heater 23, a head unit 24, a fixing section 25, and a delivery section 26.

### {Conveyance Drum}

The conveyance drum 21 includes a claw section 211 and a suction section 212 (both refer to FIG. 4) for holding the recording medium M on a conveyance surface 21a. The recording medium M is held on the conveyance surface 21a by being pressed at an end by the claw section 211 and by being sucked to the conveyance surface 21a by the suction section 212.

The conveyance drum 21 is connected to a conveyance drum motor (not illustrated) at a rotating shaft extending in its width direction. The conveyance drum 21 rotates by an angle proportional to a rotation amount of the conveyance drum motor in a state where the conveyance drum 21 holds the recording medium M on the conveyance surface 21a that is a cylindrical surface shaped outer peripheral surface. According to such control, the conveyance drum 21 conveys the recording medium M in the conveyance direction.

### {Handover Unit}

The handover unit 22 is provided at a position between the medium supplier 12 and the conveyance drum 21. The handover unit 22 hands over the recording medium M conveyed by the medium supplier 12 to the conveyance drum 21. Specifically, the handover unit 22 holds one end of the recording medium M conveyed from the medium supplier 12 with a swing arm 221 to pick the recording medium M up, and then hands over the recording medium M to the conveyance drum 21 via a handover drum 222.

### {Heater}

The heater 23 is provided between an arrangement position of the handover drum 222 and an arrangement position of the head unit 24. The heater 23 heats the recording medium M so that the recording medium M conveyed by the conveyance drum 21 becomes a temperature within a predetermined temperature range. The heater 23 includes, for example, an infrared heater, etc. The heater 23 energizes the infrared heater to cause it to generate heat on the basis of a control signal supplied from the controller 50.

### {Head Unit}

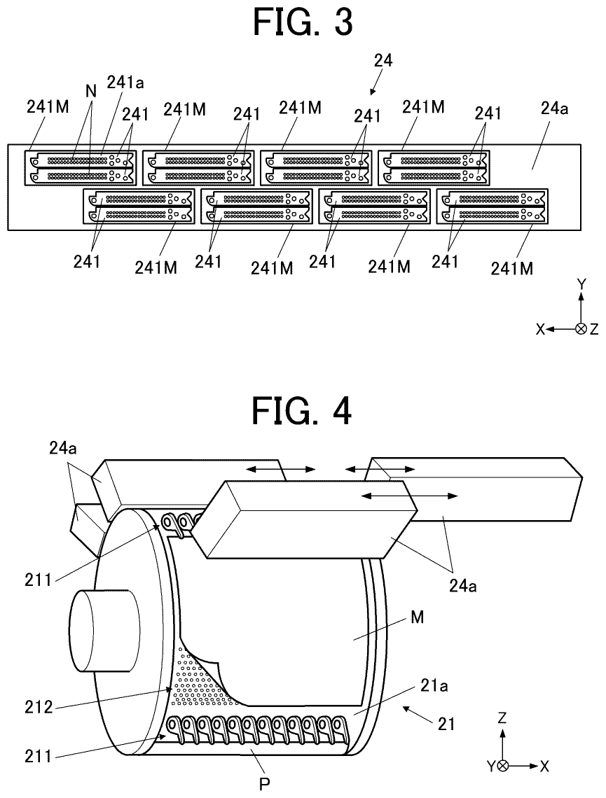

The head unit 24 includes a plurality of inkjet heads 241 (refer to FIG. 3), a head driver 242, and a carriage 24a.

The head unit 24 causes the head driver 242 to supply driving signals to the inkjet heads 241 at appropriate timings corresponding to the rotation of the conveyance drum 21 holding the recording medium M. The inkjet heads 241 that have acquired the driving signals eject ink from their nozzle surfaces 21a (refer to FIG. 3), which are ink ejection faces opposing the conveyance surface 241a, onto the recording medium M to record the image. The head unit 24 is arranged such that the nozzle surface 241a and the conveyance surface 21a are spaced apart from each other by a predetermined distance. According to the present embodiment, four head units 24 respectively corresponding to yellow (Y), magenta (M), cyan (C), and black (K) are arranged at predetermined intervals in the order of Y, M, C, and K from the upstream side in the conveyance direction.

### <Inkjet Head>

FIG. 3 is a bottom view of the entire head unit 24 as viewed from the side facing the conveyance surface 21a of the conveyance drum 21. The head unit 24 according to the present embodiment includes sixteen inkjet heads 241. The inkjet heads 241 each include, in a nozzle surface 241a portion as a lower surface thereof, a nozzle row formed of nozzles N arranged in a width direction. In addition, the nozzle surface 241a of the inkjet head 241 is covered with a water-repellent film which is an organic film made of, for example, fluorine based resin.

Note that an arrangement direction of the nozzles N in each inkjet head 241 is not limited to the width direction, but may be a direction crossing the conveyance direction at an angle other than a right angle. Furthermore, the number of inkjet heads 241 included in the head unit 24 is not limited to sixteen. The number of inkjet heads 241 may be appropriately changed according to an image recording width or the like.

### <Head Module>

Sixteen inkjet heads 241 are combined in units of two to constitute eight head modules 241M. The positions of the plurality of nozzle rows included in each head module 241M in the width direction are adjusted such that the positions of the nozzles in the width direction do not overlap each other.

Each head module 241M is fitted into an opening provided in a support plate at the bottom of the carriage 24a. Furthermore, each head module 241M is supported by the support plate in a state where the nozzle surface 241a of the inkjet head 241 is exposed from the bottom surface of the support plate. In addition, the eight head modules 241M are arranged in a staggered pattern so that a range in which ink can be ejected from the nozzles N is continuously connected in the width direction, and thus a line head is configured.

The arrangement range of the nozzles N included in the head unit 24 in the width direction covers the width of an image recording region of the recording medium M conveyed by the conveyance drum 21 in the width direction. The head unit 24 is used in a fixed position during recording of the image. The head unit 24 sequentially ejects ink at predetermined intervals to different positions in the conveyance direction as the recording medium M is conveyed, thereby recording an image by a single-pass method.

Note that the head unit 24 may record the image by a multi-pass method in which the arrangement range of the nozzles N in the width direction is shorter than the width of the image recording region in the width direction and ink is sequentially ejected while the head unit 24 is moved in the width direction.

An ink discharge mechanism for discharging ink from each nozzle N is not particularly limited, but a piezoelectric type using a piezoelectric material can be used. As the piezoelectric type ink ejection mechanism, a shear mode and a vent mode are known. The ink discharge mechanism of the shear mode causes a shear mode type displacement in the piezoelectric material of a wall surface of a pressure chamber communicating with the nozzle N to vary pressure of the ink in the pressure chamber and discharge the ink. In addition, the ink discharge mechanism of the vent mode discharges ink by changing the pressure of the ink in the pressure chamber by deforming the piezoelectric material which is fixed to a vibration plate which configures the wall surface of the pressure chamber.

The ink used for recording the image by the head unit 24 includes a property of changing its phase between a gel state and a sol state depending on temperature. The gel state is an aspect of a solid, and the sol state is an aspect of a liquid. As a composition of such an ink, for example, a composition obtained by adding several % of a gelling agent to a composition mainly including a polymerizable compound and a photopolymerization initiator is exemplified. When the ink in the gel state is heated to increase the temperature, viscosity of the ink starts to remarkably decrease at a stage where the temperature exceeds a solation temperature (for example, around 70° C.) inherent in the ink, and the ink undergoes a phase transition to the sol state. On the other hand, when the temperature of the ink in the sol state is lowered, the viscosity of the ink starts to remarkably increase at a stage where the temperature becomes lower than a gelation temperature (for example, about 50° C.) specific to the ink, and the ink is phase-changed to the gel state.

The head unit 24 includes an ink heater (not shown) which heats the ink before being supplied to the inkjet head 241 and the ink supplied into the inkjet head 241. The inkjet head 241 ejects ink, which has been heated by the ink heater and turned into the sol state, from the nozzles N. The ink ejected from the nozzles N and landed on the recording medium M is cooled and quickly phase-changes to the gel state.

The ink used in the present embodiment includes a property of being cured by irradiation with ultraviolet rays. That is, the ink used in the present embodiment is fixed on the recording medium M by irradiating the ink with ultraviolet rays to cure the ink after the ink is cooled on the recording medium M to be in the gel state.

### <Carriage>

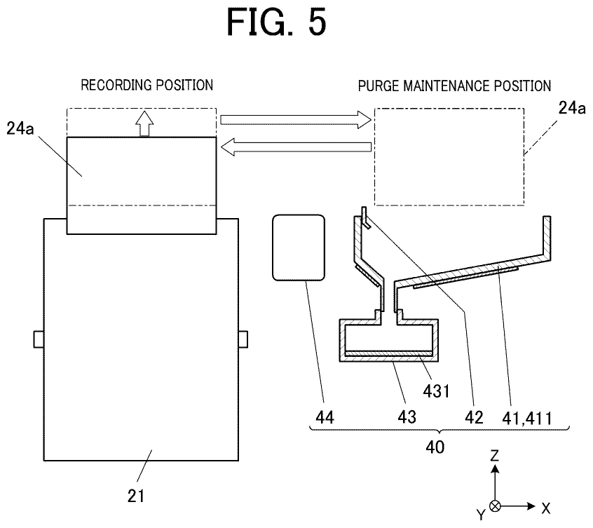

The carriage 24a carries a plurality of inkjet heads 241. The carriage 24a is provided so as to be individually movable in the width direction. FIG. 4 is a diagram illustrating the carriage 24a that moves in the width direction. FIG. 5 is a view showing a movable range of the carriage 24a in the width direction. As illustrated in FIG. 4 and FIG. 5, the carriage 24a is moved in the width direction between an image recording position and a purge maintenance position by a carriage moving section 62 (see FIG. 2) which will be described later.

The image recording position is a position at which the nozzle surface 241a faces the conveyance surface 21a. Furthermore, the image recording position is a position of the carriage 24a when the image is recorded by ejecting the ink onto the recording medium M on the conveyance surface 21a. By moving the carriage 24a in the +X direction after raising the carriage 24a at the image recording position, the carriage 24a can be moved to the purge maintenance position.

The purge maintenance position is a position of the carriage 24a when purge maintenance is performed to discharge the ink from the nozzle N of the inkjet head 241. In the purge maintenance, similarly to the recording of the image, the pressure of the ink in the pressure chamber communicating with the nozzle N is changed, and thus the ink is continuously ejected from each nozzle N. Thus, air bubbles and foreign matters mixed in the ink in the inkjet head 241 can be discharged to the outside together with the ink.

The method of the purge maintenance is not limited to this. For example, a method (pressurized purge) of forcibly discharging the ink from the nozzle N by increasing the supply pressure of the ink with respect to the inkjet head 241 may be used.

### <Head Driver>

The head driver 242 supplies, to the inkjet head 241, a driving signal for deforming the piezoelectric element in accordance with image data at an appropriate timing. Under the control, the head driver 242 causes the nozzle N of the inkjet head 241 to eject ink in an amount corresponding to a pixel value of the image data.

### {Fixing Section}

Referring back to FIG. 1, the fixing section 25 cures and fixes the ink ejected onto the recording medium M. The fixing section 25 includes an ultraviolet irradiator disposed across the width direction of the conveyance drum 21. The fixing section 25 irradiates the recording medium M placed on the conveyance drum 21 with ultraviolet rays from the ultraviolet irradiator to fix the ink. The ultraviolet irradiator of the fixing section 25 is arranged opposite the conveyance surface between the arrangement position of the head units 24 and the arrangement position of a handover drum 261 of the delivery section 26 in the conveyance direction.

### {Delivery Section}

The delivery section 26 includes the handover drum 261 and a belt loop 262. The handover drum 261 has a cylindrical shape, and hands over the recording medium M from the conveyance drum 21 to the belt loop 262. The belt loop 262 is a ring-shaped belt and its inner side is supported by two rollers. The delivery section 26 conveys the recording medium M handed over from the conveyance drum 21 onto the belt loop 262 by the handover drum 261, with the belt loop 262, and sends out the recording medium M to the sheet ejection section 30.

### (Sheet Ejection Section)

The sheet ejection section 30 includes a sheet ejection tray 31. The sheet ejection section 30 has a plate shape and the recording medium M sent out from the image forming section 20 by the delivery section 26 is placed on the sheet ejection section 30.

### (Cleaning Section)

Below the carriage 24a moved to the purge maintenance position in the height direction, a cleaning section 40 is arranged. The cleaning section 40 includes an ink receiver 41, a scraping member 42, an ink reservoir 43, and a head cleaner 44.

### {Ink Receiver}

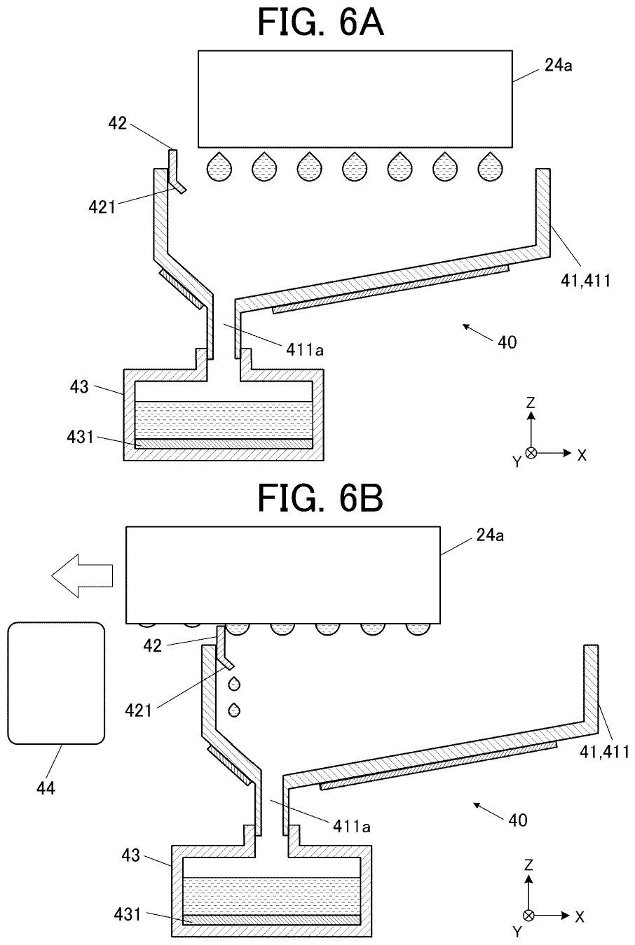

FIG. 6A is a cross-sectional view of a part of the cleaning section 40 during purge maintenance. The ink receiver 41 includes an ink tub 411 including an inclined surface inclined with respect to a horizontal plane. The ink tub 411 receives, with the inclined surface, the discharged ink discharged from the nozzle N. The material of the ink tub 411 may be, for example, aluminum, but is not limited thereto.

In the present embodiment, the case where one common ink tub 411 is provided for the four carriages 24a is exemplified, but the present invention is not limited thereto. That is, one ink tub 411 may be separately provided for one carriage 24a.

A discharge port 411a into which the ink having flowed on the inclined surface flows is provided at the bottom of the ink tub 411. Ink dropped (landed) on the inclined surface flows downward along the inclined surface due to gravity and flows into the discharge port 411a.

### {Scraping Member}

The scraping member 42 is attached to an upper end portion of a side wall of the ink tub 411 located on the −X direction side. A total of four scraping members 42 are provided, one for each carriage 24a. However, without being limited thereto, a configuration may be adopted in which one common scraping member 42 is provided for the four carriages 24a.

The scraping member 42 is a blade-shaped member that is longer than or equal to the width of the nozzle surface 241a in the conveyance direction. The material of the scraping member 42 is not particularly limited, but is, for example, any of various resins or metals. The scraping member 42 is discharged from the nozzle N in the purge maintenance and the ink adhering to the nozzle surface 241a is scraped and removed.

FIG. 6B is a diagram illustrating a cross section of the cleaning section 40 during an ink scraping operation by the scraping member 42. The upper tip end of the scraping member 42 in the height direction is arranged at a position where the tip end does not contact the nozzle surface 241a and contacts the ink adhered to the nozzle surface 241a when the carriage 24a moves in the −X direction from the purge maintenance position.

As illustrated in FIG. 6B, when the nozzle surface 241a moves in the −X direction together with the carriage 24a, the tip of the scraping member 42 comes close to the nozzle surface 241a. Next, the ink adhering to the nozzle surface 241a moves from the tip of the scraping member 42 to the side surface of the scraping member 42, and the ink is scraped and removed from the nozzle surface 241a. That is, the scraping member 42 scrapes the ink on the nozzle surface 241a in a non-contact state with respect to the nozzle surface 241a.

A receiving tray 421 is attached to the lower end of the scraping member 42. The receiving tray 421 adjusts a dropping position of the scraping ink. That is, the receiving tray 421 allows the scraped ink scraped off by the scraping member 42 to flow down to a predetermined dropping position and to flow into the discharge port 411a.

### {Ink Reservoir}

As illustrated in FIG. 6A and FIG. 6B, the discharge port 411a of the ink tub 411 is connected to the ink reservoir 43. The ink reservoir 43 stores ink that has been received by the ink tub 411 and has flowed into the discharge port 411a. An ink amount detector 431 is provided at the bottom of the ink reservoir 43. The ink amount detector 431 detects the amount of ink stored in the ink reservoir 43 and transmits the amount of ink to the controller 50. The ink amount detector 431 is, for example, a load cell that detects the weight of the stored ink. The ink amount detector 431 is not limited to the load cell, but may be, for example, a liquid level sensor that detects the height of a liquid level of the ink.

### (Head Cleaner)

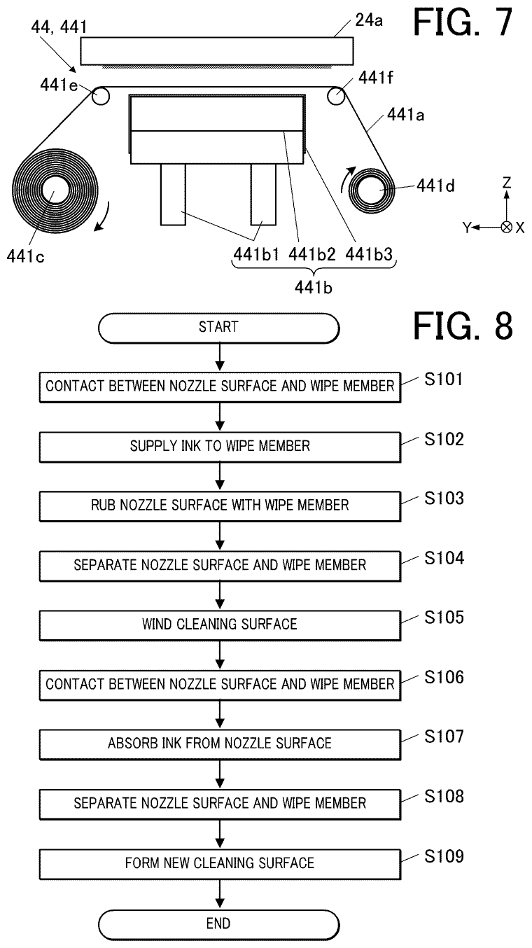

FIG. 7 illustrates the head cleaner 44. The head cleaner 44 includes a wipe unit 441. The wipe unit 441 includes a wipe member 441a, a backup member 441b, an unwinding roller 441c, a winding roller 441d, and support rollers 441e and 441f.

The wipe member 441a wipes the nozzle surface 241a. The wipe member 441a is a long object to be wound into a roll. The wipe member 441a is, for example, a fabric such as a woven fabric or a nonwoven fabric. More specifically, the wipe member 441a is a sparse cloth. The wipe member 441a is about 0.3 mm thick and has weft and warp densities of about 50 to 120 yarns/inch. The wipe member 441a is unwound from the unwinding roller 441c, is stretched between the support rollers 441e and 441f, and forms a cleaning surface for the nozzle surface 241a at a predetermined position. After the wiping of the nozzle surface 241a, the cleaning surface to which the ink adheres is wound up around the winding roller 441d.

The backup member 441b is arranged on the rear surface of the cleaning surface. The backup member 441b is provided in order to counteract a pressing force from the nozzle surface 241a to the wipe member 441a. As illustrated in FIG. 7, the backup member 441b includes a pressing spring 441b1, a pressing member 441b2, and a PET sheet 441b3.

The pressing spring 441b1 applies a predetermined urging force to the pressing member 441b2 substantially uniformly. The pressing member 441b2 has a lower portion made of a metal plate and an upper portion made of a sponge. Since the upper portion of the pressing member 441b2 is formed of a sponge, the wipe member 441a can be softly pressed against the nozzle surface 241a. Further, since the lower portion of the pressing member 441b2 is formed of a metal plate, a predetermined strength can be imparted to the pressing member 441b2. The PET sheet 441b3 is a thin sheet made of PET (Polyethylene Terephthalate) as raw material. The PET sheet 441b3 is provided so as to cover at least the entire upper surface of the pressing member 441b2. By providing the PET sheet 441b3, it is possible to suppress the ink from adhering to the sponge on the upper portion of the pressing member 441b2 which does not have ink resistance and being cured.

A detailed description of a method of cleaning the 241a of the nozzle surface by the head cleaner 44 will be given later.

### (Controller)

Returning to FIG. 2, the controller 50 is a processor that integrally controls the entire operation of the inkjet recording apparatus 1. The controller 50 includes a central processing unit (CPU) 51, a random access memory (RAM) 52, a read only memory (ROM) 53, and a storage section 54.

### {CPU}

The CPU 51 reads various control programs and data items stored in the ROM 53, stores the read programs and data in the RAM 52, and executes the programs to carry out various calculation processes.

### {RAM}

The RAM 52 provides a working memory space for the CPU 51 and stores temporary data. The RAM 52 may include a non-volatile memory.

### {ROM}

The ROM 53 stores various control programs and setting data to be executed by the CPU 51. Note that a rewritable nonvolatile memory such as a flash memory may be used in place of the nonvolatile memory ROM 53.

### {Storage Section}

The storage section 54 stores print jobs input from an external device via the communicator 64, image data of images to be recorded associated with the print jobs, and the like. As the storage section 54, for example, a hard disk drive (HDD) is used. In addition, a dynamic random access memory (DRAM) or the like may also be used as the storage section 54.

### <Conveyance Driver>

The conveyance driver 61 supplies the driving signal to the conveyance drum motor of the conveyance drum 21 on the basis of the control signal supplied from the controller 50. By the control, the conveyance driver 61 rotates the conveyance drum 21 at a predetermined speed and timing. The conveyance driver 61 also supplies driving signals to the motors for operating the medium supplier 12, the handover unit 22, and the delivery section 26 on the basis of the control signals supplied from the controller 50. Under such control, the conveyance driver 61 causes the recording medium M to be supplied to the conveyance drum 21 and ejected from the conveyance drum 21.

### <Carriage Moving Section>

The carriage moving section 62 outputs, under the control of the controller 50, the driving signal to a motor or a brake of a moving mechanism that moves the carriage 24a up and down in the height direction or moves the carriage in the width direction. Under such control, the carriage moving section 62 moves the carriage 24a between the above-described recording position and the purge maintenance position.

### {Operation/Display Part}

The operation/display part 63 displays a status and an operation menu for the inkjet recording apparatus 1, and the like in response to the control signal from the controller 50. Furthermore, the operation/display part 63 accepts a user operation and makes an output to the controller 50. The operation/display part 63 includes, for example, a liquid crystal display part in which a touch sensor as an operation acceptance unit is provided in a manner superimposed on a display screen as a display unit.

### {Communicator}

The communicator 64 is a communication interface that controls communication operation with an external device. The communication interface includes, for example, one or a plurality of interfaces compatible with various communication protocols such as a LAN board and a LAN card. Under the control of the controller 50, the communicator 64 acquires the image data to be recorded and the like from the external device. Further, the communicator 64 transmits status information and the like to the external device.

### {Bus}

The bus 65 is a path that electrically connects the above-described components to exchange signals.

### [Nozzle Surface Cleaning Operation by Head Cleaner]

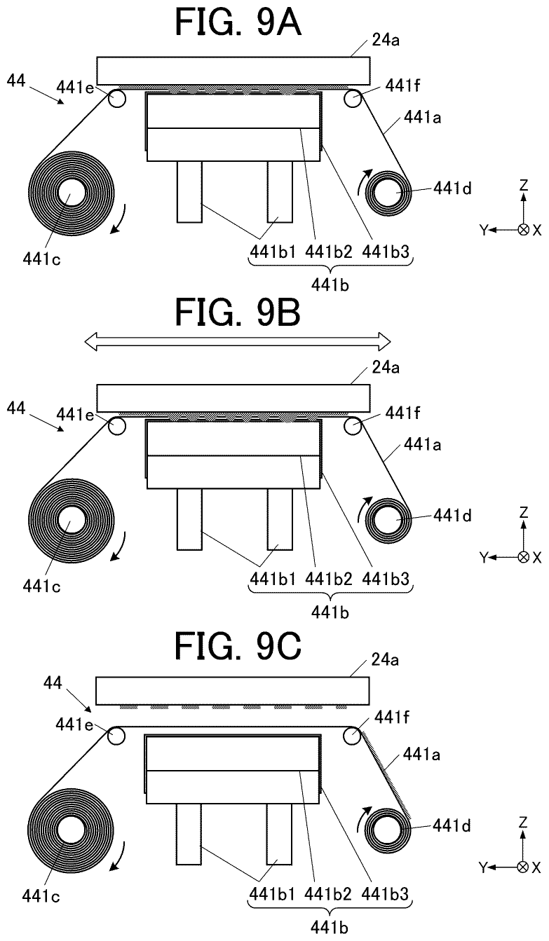

The nozzle surface cleaning operation by the head cleaner 44 as described above will be described with reference to FIG. 8 and FIG. 9A to FIG. 9E. In the present invention, the nozzle surface cleaning operation by the head cleaner 44 is executed after the purge maintenance in the nozzle tub 411 and the scraping of the ink on the nozzle surface 241a by the scraping member 42.

The controller 50 causes the carriage moving section 62 to move the inkjet head 241 to a nozzle surface cleaning position where the nozzle surface 241a faces the wipe member 441a. Then, the controller 50 causes the carriage moving section 62 to move the nozzle surface 241a downward in the height direction and bring the nozzle surface 241a into contact with the wipe member 441a (step S101). Note that a contact portion of the wipe member 441a with the nozzle surface 241a in step S101 is defined as the cleaning surface.

When the nozzle surface 241a and the wipe member 441a contact each other, the controller 50, as illustrated in FIG. 9A, supplies ink to the cleaning surface of the wipe member 441a (step S102). Since the ink is supplied in the step S102 after the nozzle surface 241a and the cleaning surface are brought into contact with each other in the step S101, it is possible to suppress the generation of ink mist during the supply of the ink.

In step S102, the controller 50 can supply the ink to the wipe member 441a by discharging the ink from all the nozzles N by the driving of the head driver 242, for example. However, the method of supplying the ink to the wipe member 441a is not limited to the above-described control.

For example, the controller 50 causes the head driver 242 to supply a driving signal for shaking the interface (meniscus) of the ink to the inkjet head 241, thereby causing the ink to come into contact with the wipe member 441a as shown in FIG. 9A. In addition, the controller 50 may wait for a predetermined amount of time while the nozzle surface 241a and the wipe member 441a are in contact with each other, thereby drawing the ink from the nozzles N by the capillary action of the wipe member 441a. Alternatively, the controller 50 may drive the carriage moving section 62 to rub the inkjet head 241 in the width direction at a lower speed than step S103 described later, thereby surely bringing the nozzle N and the wipe member 441a into contact with each other to draw out ink. However, as a method of supplying the ink to the wipe member 441a, ejection of the ink from the nozzle N described above is preferable. This is because such control can minimize the time required for the nozzle surface cleaning operation and increase the productivity of image recording.

In addition, the amount of ink applied to the wipe member 441a in step S102 may be an amount in which ink does not adhere to the backup member 441b (PET sheet 441b3 in the present embodiment) after a series of nozzle surface cleaning operations.

In other words, even if ink permeates the wipe member 441a and adheres to the backup member 441b, it is sufficient that the ink is in an amount that can be wiped by the wipe member 441a pulled out in step S105 described later. Therefore, when the maximum ink amount that can be held by the wipe member 441a is α[g/m²], a winding amount of the wipe member 441a is β[m], the width of the inkjet head 241 in the width direction is γ[m], and the ink application amount is δ[g], α, β, γ, and δ may satisfy the following inequality (1).

$$α \times β \times γ > δ \qquad Formula ( 1 )$$

This is because if the backup member 441b is contaminated with ink, the ink may be transferred to another cleaning surface of the wipe member 441a, and color mixing may occur when an inkjet head 241 of another color is cleaned. In addition, in a case of a configuration in which the backup member 441b does not include the PET sheet 441b3 and the sponge of the pressing member 441b2 is brought into direct contact with the wipe member 441a, when the ink adheres to the backup member 441b, that is, the sponge, the ink is cured. As a result, the wipe member 441a cannot be softly touched.

After the application of the ink to the wipe member 441a, as illustrated in FIG. 9B, the controller 50 drives the carriage moving section 62 to move the inkjet head 241 back and forth, thereby rubbing the nozzle surface 241a (step S103).

In the present embodiment, the wipe member 441a, which is a sparse cloth as described above, is wet with ink, and the ink enters between the fibers. Therefore, the nozzle surface 241a can be wiped by the wipe member 441a which is smoother than a dry cloth. Furthermore, since the spaces between the fibers are filled with the ink, the wipe member 441a becomes more flexible, and the contact surface with the 241a of the nozzle surface can be increased.

In addition, since the wiping is performed by reciprocating the inkjet head 241, it is possible to suppress the occurrence of deviation in the water repellent film on the nozzle surface 241a.

After rubbing the nozzle surface 241a, the controller 50 separates the nozzle surface 241a and the wipe member 441a by the driving of the carriage moving section 62 (step S104). Next, as illustrated in FIG. 9C, the controller 50 drives the unwinding roller 441c and the winding roller 441d to wind up the wipe member 441a (step S105).

The controller 50 drives the carriage moving section 62 to move the inkjet head 241 downward in the height direction, thereby bringing the nozzle surface 241a into contact with a surface different from the cleaning surface used up to step S104 (step S106). The controller 50 causes the nozzle surface 241a and the wipe member 441a to rub against each other so as to reciprocate about the 2 mm in a state where the nozzle surface 241a and the wipe member 441a are in contact with each other. Through the above-described control, as illustrated in FIG. 9D, the controller 50 causes the ink remaining on the nozzle surface 241a to be absorbed by a surface of the wipe member 441a different from the cleaning surface (step S107). By not only bringing the nozzle surface 241a and the 441a of the wipe member into contact with each other but also rubbing them against each other, even the wipe member 441a, which is a cloth having folds and roughness, can absorb all the ink on the nozzle surface 241a.

After liquid absorption of the nozzle surface 241a, the controller 50 moves the inkjet head 241 upward in the height direction by driving the carriage moving section 62 (step S108). In addition, the unwinding roller 441c and the winding roller 441d are driven to reel in the wipe member 441a, a new cleaning surface is formed (step S109), and the nozzle surface cleaning operation ends.

### Effects of Embodiment

As described above, the inkjet recording apparatus 1 according to the present embodiment includes the inkjet head 241 that ejects ink from the nozzle N provided in the nozzle surface 241a. The inkjet recording apparatus 1 further includes the head cleaner 44 to perform the nozzle surface cleaning operation of rubbing and wiping the nozzle surface 241a with the cleaning surface of the wipe member 441a. Furthermore, the inkjet recording apparatus 1 includes the controller 50 that causes the inkjet head 241 to supply ink to the cleaning surface of the wipe member 441a. Then, the head cleaner 44 performs the nozzle surface cleaning operation in a state where the cleaning surface of the wipe member 441a is wetted with ink, and uses a different region of the wipe member 441a as the cleaning surface for each nozzle surface cleaning operation. According to the above configuration, it is possible to appropriately wipe off the residual ink adhering to the nozzle surface 241a. In addition, since the residual ink is wiped by the ink instead of the cleaning liquid, it is not necessary to separately provide a device which applies the cleaning liquid, and it is possible to suppress an increase in the size and the cost of the inkjet recording apparatus 1. Furthermore, in particular, since different regions of the wipe member 441a are used as the cleaning surface, the nozzle surface 241a can be rubbed and wiped with the wipe member 441a without stains in each nozzle surface cleaning operation.

### [Other Configurations]

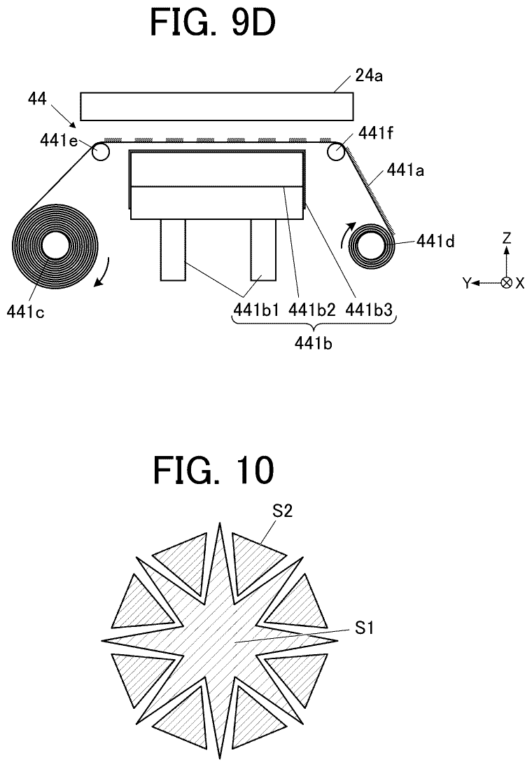

Furthermore, although the wipe member 441a is a fabric in the above description, for example, when the wipe member 441a is a woven fabric, it is preferable that yarns forming the woven fabric are split yarns having a cross section as illustrated in FIG. 10. As illustrated in FIG. 10, the split yarn is formed by combining two fibers S1 and S2. In addition, nylon fibers are used as the fibers S1, and polyester fibers are used as the fibers S2. Thus, the split yarn is composed of the fibers S1 and S2 of two different materials, and is subjected to the opening treatment. Therefore, the split yarn is a yarn in which the fiber is broken and which is thinner and has a distorted shape. Thus, since the split fibers have a fine fiber texture, the liquid absorbency of the wipe member 441a can be improved. In addition, since the split yarn is a fiber having a distorted shape, it is possible to improve the ink scraping properties at the time of rubbing.

Furthermore, although the configuration in which the nozzle surface cleaning operation is performed after the purge maintenance and the ink scraping has been described above, it is not limited thereto. That is, the inkjet recording apparatus 1 may have a plurality of cleaning modes, and for example, may perform only the nozzle surface cleaning operation without performing the purge maintenance and the scraping of the ink.

Furthermore, although it is described above that the amount of ink supplied to the wipe member 441a in step S102 only needs to satisfy the inequality (1), it goes without saying that it needs to be an amount that can wipe off the thickened ink adhering to the nozzle surface 241a.

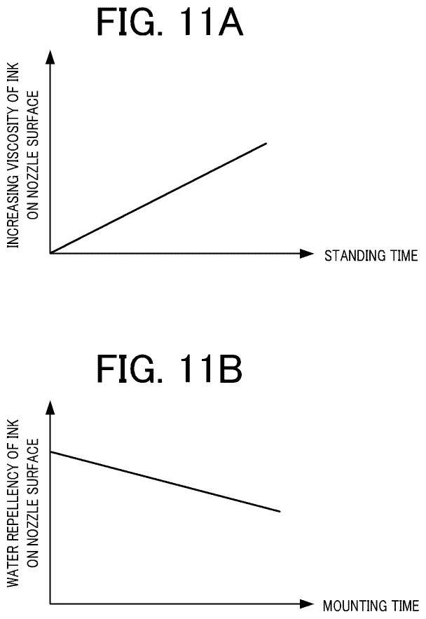

Therefore, the adhesion situation of the thickened ink on the nozzle surface 241a may be predicted, and the supply amount of the ink to the wipe member 441a may be adjusted based on the prediction result. To be specific, as illustrated in FIG. 11A, as the elapsed time (standing time) from the image formation processing after the last nozzle surface cleaning operation becomes longer, the increasing viscosity of the thickened ink on the nozzle surface 241a increases. This is because drying and adhesion of a discharge product progresses as the standing time of the thickened ink becomes longer. Therefore, the amount of ink supplied to the wipe member 441a may be increased in accordance with the elapsed time since the last nozzle surface cleaning operation.

Furthermore, the ease of wiping of the thickened ink on the nozzle surface 241a may be predicted, and the amount of ink supplied to the wipe member 441a may be adjusted on the basis of the prediction result. To be specific, as shown in FIG. 11B, as the mounting period of the inkjet head 241 becomes longer, the water repellency of the ink on the nozzle surface 241a decreases, and it becomes difficult to wipe off the thickened ink. This is due to the fact that when the mounting period of the inkjet head 241 is long, the number of times of the nozzle surface cleaning operation increases correspondingly and the water-repellent film is removed. Therefore, the amount of ink to be supplied to the wipe member 441a may be increased according to the mounting period of the inkjet head 241.

Furthermore, although the controller 50 causes the nozzle surface 241a to contact and separate from the wipe member 441a by driving the carriage moving section 62 in the above description, the present invention is not limited to this. That is, a configuration may be adopted in which the wipe member 441a can be raised and lowered in the height direction, and the wipe member 441a is brought into contact with and separated from the nozzle surface 241a.

In addition, in the above description, the inkjet recording apparatus 1 includes the head cleaner 44, but the invention is not limited thereto, and the head cleaner 44 may be an apparatus separate from the inkjet recording apparatus 1.

In addition, in the above description, an example in which ROM 43 is used as a computer-readable medium of the program according to the present invention has been disclosed, but the present invention is not limited to this example.

As other computer-readable media, a nonvolatile memory such as a flash memory and a portable recording medium such as a CD-ROM can be applied.

As a medium for providing data of the program according to the present invention via a communication line, a carrier wave is also applied to the present invention.

In addition, specific details such as the configurations, structures, arrangements, control details, and procedures of the inkjet recording apparatus 1 and the head cleaner 44 described in the above embodiment can be appropriately modified without departing from the spirit and scope of the present invention.

Although embodiments of the present invention have been described and shown in detail, the disclosed embodiments are made for purposes of illustration and example only and not limitation. The scope of the present invention should be interpreted by terms of the appended claims.

The entire disclosure of Japanese Patent Application No. 2024-062966, filed on Apr. 9, 2024, including description, claims, drawings and abstract is incorporated herein by reference.

What is claimed is:

1. An inkjet recording apparatus comprising:
an inkjet head that ejects ink from a nozzle provided on a nozzle surface;
a head cleaner that performs a nozzle surface cleaning operation of rubbing and wiping the nozzle surface with a cleaning surface of a wipe member; and
a hardware processor that causes ink to be supplied from the inkjet head to the cleaning surface of the wipe member,
wherein the head cleaner performs the nozzle surface cleaning operation in a state in which the cleaning surface of the wipe member is wetted with the ink, and sets a different region of the wipe member as the cleaning surface each time the nozzle surface cleaning operation is performed.

2. The inkjet recording apparatus according to claim 1, wherein when a maximum ink amount that the wipe member can hold is α[g/m²], a winding amount of the wipe member in the nozzle surface cleaning operation is β[m], a width of the inkjet head is γ[m], and an ink amount supplied from the inkjet head is δ[g], α, β, γ, and δ satisfy a relation of the following formula (1):
$$α \times β \times γ > δ . \qquad Formula ( 1 )$$

3. The inkjet recording apparatus according to claim 1, wherein the hardware processor causes the ink to be supplied to the wipe member by ejecting the ink from the inkjet head in a state in which the inkjet head is in contact with the wipe member.

4. The inkjet recording apparatus according to claim 1, wherein the hardware processor causes the ink to be supplied to the wipe member by causing the inkjet head to wait for a predetermined amount of time in a state in which the inkjet head is in contact with the wipe member.

5. The inkjet recording apparatus according to claim 1, wherein the hardware processor causes the ink to be supplied to the wipe member by vibrating a meniscus.

6. The inkjet recording apparatus according to claim 1, wherein the hardware processor causes the ink to be supplied to the wipe member by sliding the wipe member on the inkjet head at a speed lower than during wiping in the nozzle surface cleaning operation.

7. The inkjet recording apparatus according to claim 1, wherein the hardware processor causes the ink to be supplied from the inkjet head to the wipe member by an amount corresponding to an elapsed time from the previous nozzle surface cleaning operation.

8. The inkjet recording apparatus according to claim 1, wherein the hardware processor causes the ink to be supplied from the inkjet head to the wipe member by an amount corresponding to a mounting period of the inkjet head.

9. The inkjet recording apparatus according to claim 1, wherein, after the nozzle surface is wiped with the cleaning surface of the wipe member wetted with the ink, the hardware processor causes a surface of the wipe member different from the cleaning surface to absorb the ink on the nozzle surface.

10. The inkjet recording apparatus according to claim 9, wherein the hardware processor causes the surface of the wipe member different from the cleaning surface to be in contact with the nozzle surface and waits for a predetermined amount of time to absorb the ink on the nozzle surface.

11. The inkjet recording apparatus according to claim 9, wherein the hardware processor causes the surface of the wipe member different from the cleaning surface to be in contact with the nozzle surface and rubs the nozzle surface to absorb the ink on the nozzle surface.

12. A nozzle surface cleaning method by an inkjet recording apparatus including, an inkjet head that ejects ink from a nozzle provided on a nozzle surface, and a head cleaner that performs a nozzle surface cleaning operation of rubbing and wiping the nozzle surface with a cleaning surface of a wipe member, the method comprising:
supplying ink from the inkjet head to a cleaning surface of the wipe member;
performing the nozzle surface cleaning operation in a state in which the cleaning surface of the wipe member is wetted with the ink; and
changing the cleaning surface by setting a different region of the wipe member as the cleaning surface each time the nozzle surface cleaning operation is performed.

13. The nozzle surface cleaning method according to claim 12, further comprising allowing the cleaning surface to contact with the nozzle surface before the supplying.

14. The nozzle surface cleaning method according to claim 12, further comprising absorbing the ink on the nozzle surface with a surface different from the cleaning surface of the wipe member after the cleaning.
